(19) United States
(12) Patent Application Publication
(10) Pub. No.: US 2012/0005108 A1
(43) Pub. Date: Jan. 5, 2012

(54) METHOD AND SYSTEM FOR PROVIDING A GUARANTEED OFFER PRICE FOR A VEHICLE

(75) Inventors: Robert HOLLENSHEAD, Exton, PA (US); Theodore Reimel, Wayne, PA (US)

(73) Assignee: BUYBOOK TECHNOLOGY, INC., Manheim, PA (US)

(21) Appl. No.: 12/829,442

(22) Filed: Jul. 2, 2010

(51) Int. Cl. G06Q 10/00

(52) U.S. Cl. 705/306

(57) ABSTRACT

Methods and systems for generating a guaranteed offer price for a vehicle are disclosed. An appraisal device selects a price adjustment category for the vehicle from a set of stored price adjustment categories. The appraisal device determines a base value for the vehicle by modifying a market value of a vehicle type based on an amount corresponding to the selected price adjustment category. Modifiers are determined based on vehicle information received from the user computer and the price adjustment category selected from the data storage device. The modifier is limited to a threshold value. The appraisal device determines guaranteed offer price for the vehicle by combining the base value and the modifier values. An offer certificate is provided to the user that indicates the guaranteed offer price for the particular vehicle, which the appraiser is obligated to pay the dealer.

### FIELD

The disclosed embodiments relate to vehicle appraisal systems.

### BACKGROUND

Internet vehicle appraisal services evaluate a user's vehicle and provide an estimated value. These services may request information describing the type of vehicle, including its make, model and year. Using this information, the services determine an initial value. An estimated value is then calculated by modifying the initial value using the vehicle's mileage, options (e.g., color, transmission), general condition (e.g., poor, fair, good) and location.

The estimated value represents the price a seller might receive from a buyer in a sale of any vehicle possessing substantially the same characteristics as those provided by the user. Of course, the estimated value could correspond to thousands of different vehicles and, as such, does not represent the actual value of the user's particular vehicle.

The user may rely on the estimated value as a reference when negotiating the price of the vehicle with a buyer. However, the actual value of the particular vehicle is determined by a negotiated agreement between the buyer and the user. For instance, a used car dealer might consider the estimated value, but would not necessarily rely on it. Instead, the dealer would make an offer for the vehicle based on the dealer's own appraisal.

Some online appraisal services have provided users an actual price for a vehicle. For instance, International Application No WO 01/71458 A2, the disclosure of which is incorporated herein in its entirety by reference, describes an online vehicle appraisal system that provides users an actual value for their vehicle on a printable certificate.

### SUMMARY

Embodiments disclosed herein provide methods and systems that determine a guaranteed offer price that an appraiser will pay a dealer for a user's specific vehicle. The exemplary methods and systems select a price adjustment category for the vehicle from a set of price adjustment categories based on vehicle description information received from the user computer; determine a base value for the vehicle by modifying a market value of a vehicle description retrieved from the database based on an amount corresponding to the selected price adjustment category; and determine modifier values based on vehicle information received from the user computer. The guaranteed offer price for the vehicle is determined by combining the base value and the modifier values. The guaranteed offer price is a value the appraiser will pay the dealer for the user's specific vehicle after the dealer has purchased the vehicle from the user.

### BRIEF DESCRIPTION OF THE DRAWINGS

FIG. 1 is a block diagram illustrating an exemplary environment;

FIG. 2 is a block diagram illustrating an exemplary appraiser computer; and

FIG. 3 is a process flow chart illustrating exemplary steps performed by the appraiser computer.

### DETAILED DESCRIPTION

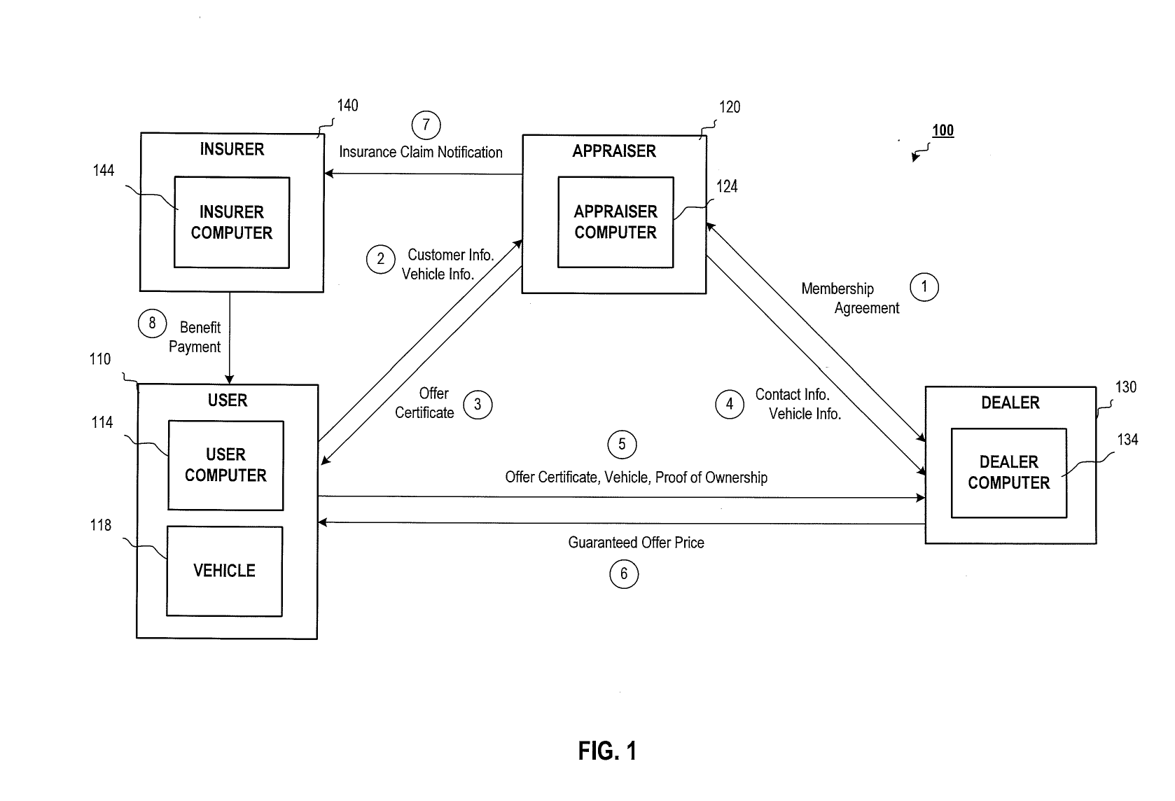

FIG. 1 is a block diagram illustrating an exemplary environment 100 in which the methods and systems of the present disclosure may be implemented. Environment 100 includes a user 110, an appraiser 120, a dealer 130 and an insurer 140. User 110 may be an entity that possesses a vehicle 118 and holds the title to the vehicle. User 110 may be, for example, a consumer, a vehicle manufacturer, a vehicle dealer, a bank, an insurance company, a research and marketing company, or a leasing agency. Appraiser 120 can be an individual or business entity that provides a vehicle appraisal service to users, such as user 110. Dealer 130 can be a vehicle dealer that is a member of application appraiser 120's service. Insurer 140 can be any insurance provider that has a policy covering user 110's risk of lost value in vehicle 118 in the event that vehicle 118 is involved in an accident resulting in an insurance claim for the repair of the vehicle.

User 110, appraiser 120, dealer 130 and/or insurer 140 may communicate using user computer 114, appraiser computer 124, dealer computer 134, and insurer computer 144 respectively. Computers 114, 124, 134 and/or 144 may be information processing systems, such as a general-purpose computer, server, or application-specific device (e.g., a set-top box or a mobile telephone) that can be communicatively linked.

Communication links between computers 114, 124, 134 and/or 144 can be wired or wireless links using a variety of communication protocols. The particular composition and protocol of the communication links is not critical as long as it allows for communication between user computer 114, appraiser computer 124, dealer computer 134 and/or insurer computer 144. In some embodiments, the communication links can be a direct connection, such as an analog, a serial or a parallel interface. In other embodiments, the communication links may be shared, public, private, or peer-to-peer networks, encompassing any wide or local area network, such as an extranet, an intranet, the Internet, a Local Area Network (LAN), a Wide Area Network (WAN), a virtual private network (VPN), a voice over internet packet network (VoIP), a public switched telephone network (PSTN), an Integrated Services Digital Network (ISDN), or any other form of wired or wireless communication. Further, the communication links can be compatible with any type of communications protocol used by the components of system environment 100 to exchange data, such as the Ethernet protocol, ATM protocol, Transmission Control/Internet Protocol (TCP/IP), Hypertext Transfer Protocol (HTTP), Hypertext Transfer Protocol Secure (HTTPS), or peer-to-peer protocol.

Environment 100 portrays exemplary relationships between user 110, appraiser 120, dealer 130 and/or insurer 140 in some of the embodiments disclosed herein. As shown in FIG. 1, dealer 130 has an established membership agreement with appraiser 120. (Step 1.) The membership agreement may require appraiser 120 to purchase specific vehicles (e.g., vehicle 118) that users (e.g., user 110) have sold to dealer 130 using offer certificates generated by appraiser computer 124. In addition, the membership agreement may require dealer 130 to pay appraiser 120 some fee or other consideration to be a member of appraiser 120's service. In some embodiments, appraiser 120 may provide user 110's contact information to dealers that belong to the appraiser 120's service.

The membership agreement with appraiser 120 may also require dealer 130 to accept offer certificates and pay guaranteed offer prices provided by appraiser 120 to user 110. In addition, the agreement may require dealer 130 to inspect any vehicle or title presented by user with an offer certificate to verify that the user is the owner of the vehicle and/or that the vehicle information provided by user 110 to appraiser computer 124 is correct.

User computer 114 may access the appraisal service through appraiser computer 124. Via user computer 114, appraiser computer 124 may prompt user 110 to provide contact information and vehicle information. (Step 2.) Contact information may include the user's name, address, electronic mail address and/or telephone number. Vehicle information may include information describing the type of vehicle, the vehicle's condition and the vehicle's history. A vehicle's description information may include: make, model, year, trim level, color and/or options. Condition information may include: mileage, wear-and-tear and/or damage. History information may include: ownership information, maintenance information, accident information and/or insurance information.

User 110 may provide contact information and vehicle information to appraiser computer 124 within an online session comprised of an interactive interview conducted through a user interface provided by appraiser computer 124 to user computer 114 which prompts user 110 to provide the information in a piecemeal manner. However, the disclosed embodiments are not limited to such examples. User 110 may provide contact information and vehicle information can be provided at different times before or during an appraisal session. For instance, the information may be provided prior to a session using a paper or electronic form from which the information may be extracted and stored for retrieval at a later time. In some embodiments, user 110 may provide contact information and vehicle information as part of a user-registration process. The information can then be retrieved and/or updated by user 110 in a later appraisal session.

Based on the received vehicle information, appraiser computer 124 determines a guaranteed offer price for user 110's specific vehicle 118. Appraiser computer 124 may provide the guaranteed offer price for the vehicle to user 110 on an offer certificate. (Step 3.) The offer certificate is a voidable offer by appraiser 120 to buy vehicle 118 from a dealer that is a member in appraiser 120's service at the guaranteed offer price.

The offer certificate may be a paper or electronic document that identifies one or more of the following: user 110, vehicle 118, dealer 130, the guaranteed offer price, an issue date/time and an expiration date/time. The certificate may also include other information to allow a third party, such as dealer 130 and appraiser 120, to verify that the certificate is authentic and unmodified (e.g., code, key, hash, checksum, watermark, etc.)

Appraiser computer 124 may provide user 110's contact information to one or more dealers based on the dealers' membership agreement with appraiser 120. (Step 4.) For instance, dealer 130 may pay for a higher membership level than another dealer so as to receive more contact information from contact information of a wider range or type of users.

In some embodiments, the membership levels may be predetermined and appraiser computer 124 may automatically forward contact information to a particular dealer based on its level. For example, the dealer may receive customer information for all users or for some users based on vehicle type (e.g., car, sport-utility vehicle, truck, and commercial vehicle), make (e.g., Ford, Chevrolet, Honda) or any other vehicle information.

Alternatively or additionally, vehicles available for sale to or purchase from contacts may be posted on an online bulletin board that is accessible by all member dealers over a network. All member dealers in the service may view the bulletin board. However, the dealers may have limited access to the contact information associated with the listed vehicles based on the dealers' respective membership levels. In this way, an individual dealer 130 may be motivated to increase its membership level in appraiser 120's service to obtain access to additional sales leads that dealer 130 becomes aware of via the bulletin board.

User 110 may present vehicle 118 and proof of ownership (e.g., title) to any dealer that is a member of appraiser 120's service, such as dealer 130. (Step 5.) Dealer 130, as required by its membership agreement with appraiser 120 may inspect vehicle 118. In some embodiments, dealer 130 receives the offer certificate an vehicle information from appraiser computer 124 or user computer 114. In other embodiments, user 110 may carry a printed copy of the vehicle information to the dealer with the offer certificate.

Dealer 130 may compare the results of its inspection to the vehicle information. For instance, dealer 130's inspection may note that vehicle 118 has one-inch scratch on the vehicle's right-rear door. In such case, dealer 130 may confirm that user 110 disclosed this damage in the vehicle information provided to appraiser computer 124. If the inspection proves the vehicle information accurate, dealer 130 may then be obligated by their membership agreement to purchase the vehicle from the user for the guaranteed offer price provided to the user by appraiser computer 124. (Step 6.) If the inspection proves that the vehicle information is inaccurate, the dealer may then instead be required to void the offer certificate. In such case, user 110 and/or dealer 130 may update the vehicle information previously provided to appraiser computer 124 using the feedback received from the dealer's inspection. Based on the updated vehicle information, appraiser computer 124 may then issue a new offer certificate.

After dealer 130 purchases vehicle 118, appraiser 120 may be obligated by its membership agreement with the dealer to honor the offer certificate and to purchase vehicle from dealer 130 for the guaranteed offer price indicated on the offer certificate. The dealer, however, is not necessarily obligated to sell vehicle 118 to appraiser 120. As such, dealer 130 may attempt to sell vehicle 118 to some entity other than appraiser 120 to obtain a better price than the guaranteed offer price. Accordingly, dealer 130 has no risk in accepting the offer certificate and paying the guaranteed offer price. In some embodiments, dealer 130 only has a limited time to sell vehicle 118 to appraiser after purchasing the vehicle from user 110. The time limit may be included in the certificate information 242 and/or indicated on the offer certificate.

Embodiments consistent with the description above allow the sale of vehicle 118 in which there is no haggling over the vehicles price between user 110 and dealer 130 occurs. That is, the price paid by dealer 130 to user 110 for vehicle 118 is determined by appraiser computer 124—not by the user or the dealer.

In some embodiments, user 110 may have an insurance policy through insurer 140 that covers some or all of the value of vehicle 118 that may be lost due to damage from an accident and/or an insurance claim. Accordingly, appraiser 120 may notify user 110 and/or insurer 140 in the event that appraiser computer 124 has reduced the guaranteed offer price due to an accident. (Step 7.) In such case, user 110 may file a claim with insurer 140 to receive a benefit payment based on the amount indicated by appraiser computer 120. (Step 8.) Alternatively, insurance computer 144 may automatically generate a payout to either user 110 or appraiser 120 based on the deduction amount indicated by appraiser computer and adjust the guaranteed offer price accordingly.

The environment illustrated in FIG. 1 is a simplified example having only a single user 110, appraiser 120, dealer 130 and insurer 140, each shown as communicating over a single communication link using a single data processing device. The disclosed embodiments are not so limited and may include any number of users, dealers, appraisers, insurers and data processing devices that communicate over a variety of communication links and networks. Additionally, the steps of FIG. 1 are exemplary. Different embodiments may include fewer or greater numbers of steps. The steps may also occur in a different order than in the example above.

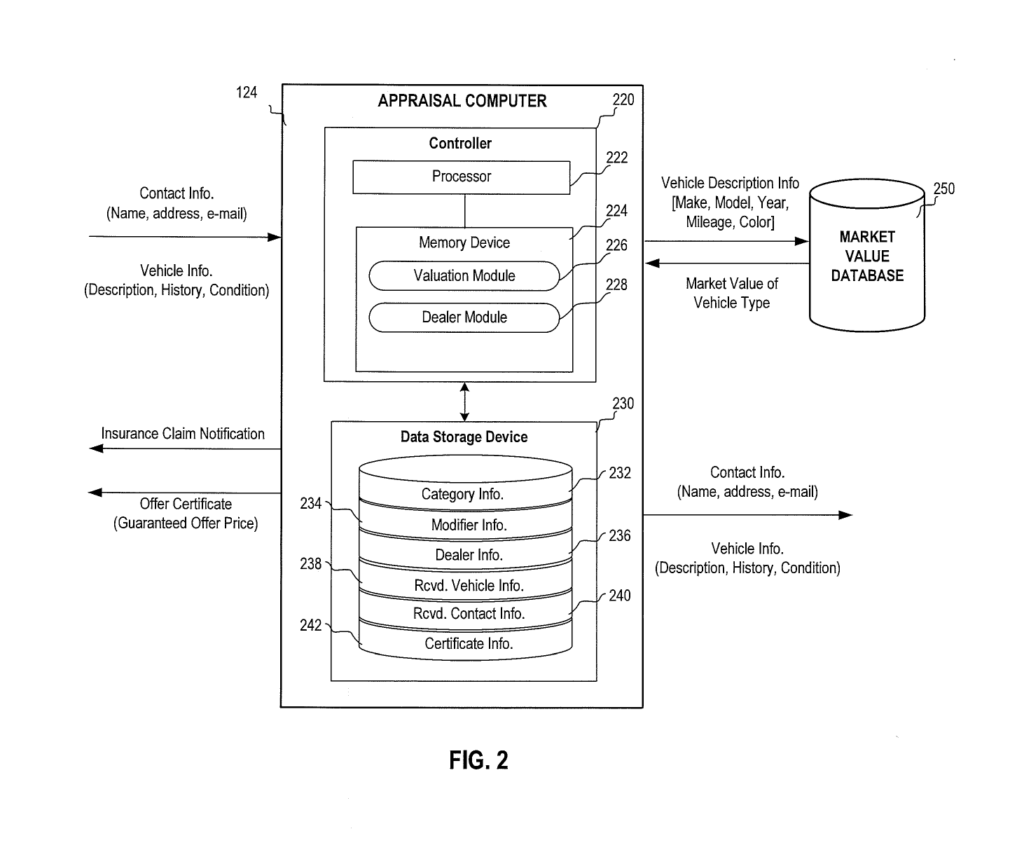

FIG. 2 is a block diagram of an exemplary appraiser computer 124 having a controller 220, memory device 224, data storage device 230 and a market value database 250. Appraiser computer 124 can be one or more devices or systems for receiving, storing, and/or processing user information, and for providing guaranteed offer prices for vehicles. Appraiser computer 124 can be implemented as one or more computer systems including, for example, a personal computer, minicomputer, microprocessor, workstation, mainframe, or similar computing platform.

Appraiser computer 124 may include for example, a controller 220 communicatively linked to a data storage device 230 and a market value database 250. Controller 220 may include, for example, a processor 222 and a memory device 224, in addition to other components, such as a clock, a communication interface, a data bus, an input/output device, a user-input device and a display device (not shown). Processor 222 may be a general-purpose processor (e.g., INTEL), or a specialized, embedded processor (e.g., ARM). Memory device 224 may be a random access memory (“RAM”), a read-only memory (“ROM”), a FLASH memory, or the like. Memory device 224 can store instructions that, when executed by the processor 222, configures appraiser computer 124 as a special-purpose machine that performs the functions described herein.

Data storage device 230 can be, for example, a magnetic disk drive, an optical disk drive, a flash memory, or other device capable of storing computer-readable information. As shown in FIG. 2, data storage device 230 may store information including, vehicle category information 232, modifier information 234, dealer information 236, received vehicle information 238, received contact information 240 and offer certificate information 242.

Category information 232 includes a set of predefined vehicle categories. The categories may be selected based on a subset of the vehicle information. For instance, a vehicle's particular colors may have a substantial affect on the vehicle's value. As such, in some embodiments, the categories can be defined by a vehicle's year, make, model and color. Of course other combinations of vehicle information may be used to define categories.

The different categories may have corresponding vehicle information, such as make, model, year, exterior color and/or interior color. Using the corresponding vehicle information, appraiser computer 124 may select a category corresponding to user 110's vehicle 118. The categories are associated with “category adjustment” information that may be used to modify the value of the vehicles belonging to that category to generate a base value for a vehicle type. The category adjustment may be a single value, a set of values, or an algorithm for determining a value. The category adjustment may be stored directly in the category dataset or the dataset could reference the information stored in another location within data storage device 230. Where the category adjustment is an algorithm, the category adjustment may be determined by one or more portions of the vehicle information. For instance, the category adjustment algorithm may determine a curve that relates the adjustment value to a vehicle's year, color and/or mileage.

In some cases, a “category adjustment” is used to modify the market value of vehicle 118 retrieved by valuation module 226 from market value database 250. Thus, for instance, appraiser computer 124's guaranteed offer price may account for a particular vehicle of a year/make/model/trim in which a particular color combination has a greater value than a similar vehicle having a less desirable color combination.

Alternatively or additionally, a selected category may include values that affect the modifier information 234 retrieved based on the condition information and history information provided by user 110. By altering modifier values based on categories information 232, appraiser computer 124's guaranteed offer price may account for the value of a particular vehicle of a make/model/trim being affected more or less based on condition or history information. For instance, a dent in the driver's side door may have a greater affect on the value of a top-of-the-line luxury automobile than the same damage would on an economy car.

Modifier information 234 is a set of data that modifies the base value of a vehicle type based on condition information and history information provided from user computer 114. Condition information may include wear and damage to vehicle 118. For instance, mechanical condition (e.g., frame, engine, transmission, suspension, brakes, wheels) and cosmetic condition (e.g., scratches, dents, dings, cracks, tears, scrapes, burns, odors). In the case where the vehicle is an automobile, the vehicle condition information may include the condition of features such as: mileage, bumpers, exterior body, windshields, tires, seats, door panels, dashboard, and frame. History information may include vehicle 118's maintenance and accident history (e.g., proof of regular maintenance, warranty, recalls, accidents, insurance claims.)

The vehicle information collected about vehicle 118's condition and history may be very specific. For example, in the case of a scratch, valuation module 226 may request information about the scratch's location, size, depth and any attempted repair. Further, appraiser computer 124 may inquire about any after-market options or modifications. Using the vehicle information received from user computer 114, valuation module 226 may retrieve corresponding modifier information 234 from data storage device 230. For instance, for each scratch user 110 reports on vehicle 118, a deduction value may be retrieved from modifier information 234. The deduction (or addition) value received may be increased on decreased based on the selected category adjustment for vehicle 118.

Modifier information may be associated with a maximum modifier threshold that limits the total modification of the base value. The threshold may be a flat amount or the threshold may represent a percentage of the base value. For example, valuation module 226 may retrieve a modifier value from the stored modifier information 234 that reduces the value of vehicle 118 by a certain amount if a passenger had smoked in the vehicle one. The amount may be increase for each incidence of smoking. However, based on the associated threshold value, the base value may not be reduced by more than thirty percent.

Dealer information 236 may include records corresponding to dealers, such as dealer 130, which are members of appraiser 120's service. Dealer information may include a member type, a vehicle type, a market type, a location and point of contact. The member type may describe a predetermined number of types of memberships the dealer has taken in appraiser 120's service. The member type may indicate to dealer module 228 which contact information that is collected by valuation module is provided to different dealers. For instance, a Type-I membership may receive contact information for any user that is provided to appraiser computer 124. Type-II members may receive less contact information depending on the dealer information and the contact information. Type-III members may receive no contact information. In some embodiments, Type-II members may receive contact information based on a hierarchy from users located within a certain range of a dealership, maker type and/or vehicle type.

Contact information 240 may be personal information received from users, such as user 110. The contact information may include, for example, the user's name, address, e-mail address and/or telephone number. Offer certificate information 242 may be a set of information recording some or all of the information included in corresponding offer certificates that have been generated by appraiser computer 124.

Market value database 250 is a searchable database of market values. As shown in FIG. 2, market value database 250 can be part of appraiser computer 124. In other embodiments, the database 250 can be generated and maintained by a third party provider. Market value database 250 may store a library of vehicle market values. Given some vehicle description information, market value database may provide a current market value for the corresponding vehicle. The market information may be retrieved in response in a query to the market value database. The query result may be a market value for a vehicle that exactly matches or most closely matches the vehicle type identified in the query. For instance, the information in market value database 250 may be accessible by vehicle identification number (VIN) or simply by designated description information, such as year, make, model, body type and/or trim level.

The market value received from market value database 250 may be modified by one or more pieces of vehicle information. In some embodiments, for example, appraiser 120 and/or appraiser computer 124 may refine the market value based on vehicle 118's mileage, general condition and/or location. Using this additional vehicle information, the market value can be increased or decreased to provide a more accurate market value for the type of vehicle identified in the query.

The information and functions of the market value database 250 and modifier information 234 may be combined into a single database of information. Using the modifier information 234, market value database 250 can provide modifier values that can be used to refine the market value of a vehicle type based on a particular vehicle's condition information and history information. When combined with category information 232 selected for vehicle 118, appraiser computer 124 may generate a guaranteed offer price for that particular vehicle.

In some embodiments, market value database 250 is included in appraiser computer 124 and is maintained by appraiser 120. In other embodiments, market value database 250 may be located apart from appraiser computer and/or be maintained by an independent entity. Furthermore, market value database may aggregate information from a number of different market databases that may be maintained by the appraiser as well as different entities.

As further shown in FIG. 2, memory device 224 can store program modules that, when executed by controller 220, control appraiser computer to perform particular functions described below. Valuation module 226 includes executable instructions and data stored in memory device 224 that, when executed by processor 222, determines a guaranteed offer price for vehicle 118. The valuation module 226 may generate a computer-user interface and perform an interactive interview with user 110 to collect contact information and information of vehicle 118. The interview may be performed consistent with that described in International Application No. WO 01/71458 A2, for example. The received vehicle information 238 may be stored in data storage device 230.

Based on the vehicle information received from user computer 114 and stored in data storage device 230, valuation module 226 may query market value database 250 to retrieve a market value corresponding to vehicle 118. Market value database 250 stores a limited set of information corresponding to a type of vehicle rather than a particular vehicle. That is, market database may store values corresponding to make, model, options, mileage and/or general condition (e.g., clean, average or rough) that may be submitted to the database. The value can apply to thousands of vehicles meeting these descriptors. As such, the market value represents a value for a vehicle type. In response, the database can provide an estimated value based on the type of vehicle having corresponding mileage and options and condition. The retrieved value may be a wholesale value, a certified pre-owned value, a retail value or a trade-in value.

Valuation module 226 may transmit an offer certificate to user computer 114 listing a guaranteed offer price for vehicle 118. The offer certificate may also include the vehicle condition information (e.g., listing damage and wear that the vehicle may have endured). When valuation module 226 determines that the guaranteed offer value for vehicle 118 should be reduced due to a collision or other damage claimed to an insurer, valuation module may 226 may also provide a notification to insurer 140.

Dealer module 228 includes program instructions and data that, when executed by processor 222, controls appraiser computer 120 to exchange information with dealer computer 124. Dealer module 228 may retrieve dealer information 236 stored in data storage device 230. Based on dealer information 236, appraiser computer 124 may provide contact information to dealer 130 and/or dealer computer 134. For instance, based on dealer information 236, appraiser computer may determine whether dealer 130 should receive contact information user 110 as a sales lead. Appraiser computer 124's determination of whether to provide dealer 130 or dealer computer 134 may be based on contact information, vehicle information and dealer information.

As disclosed herein, embodiments and features can be implemented through computer hardware, software and/or firmware. Such embodiments can be implemented in various environments, such as networked and computing-based environments with one or more users. The present invention, however, is not limited to such examples, and embodiments can be implemented with other platforms and in other environments.

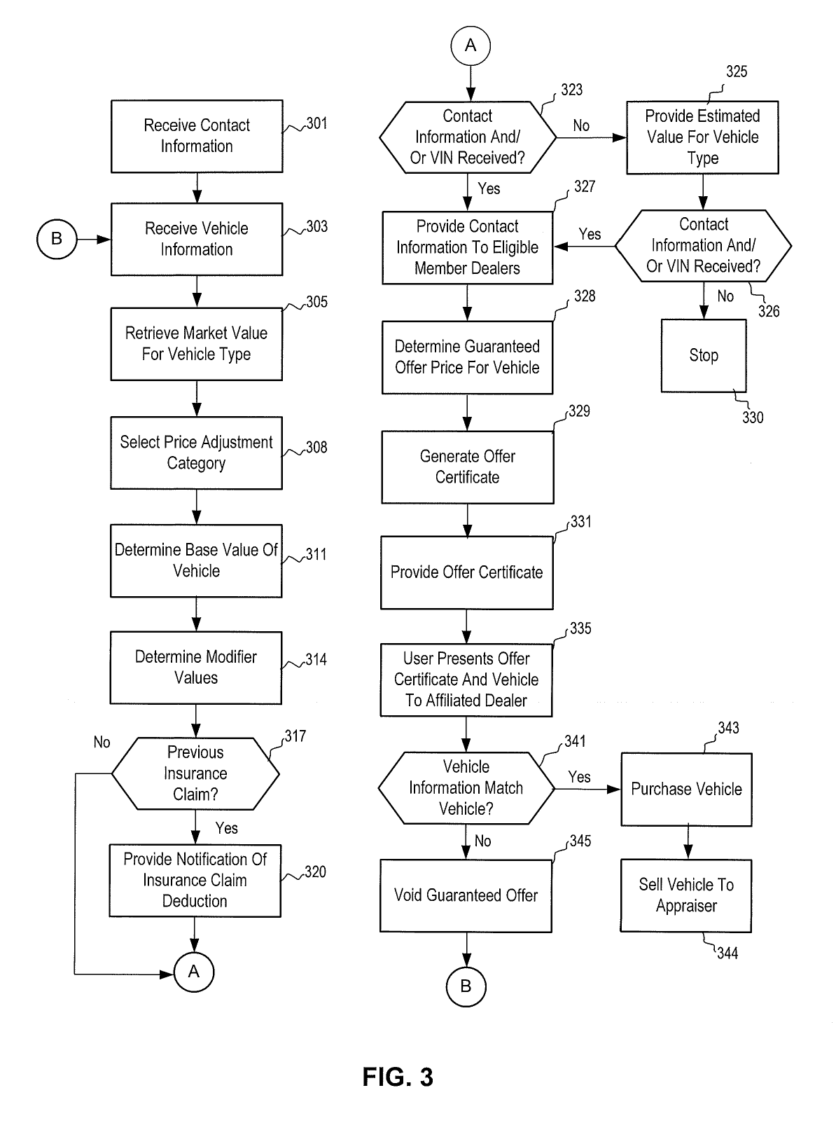

FIG. 3 illustrates an exemplary method for providing user 110 a guaranteed offer price for vehicle 118 by appraiser computer 124. Appraiser computer 124 receives contact information (step 301) and/or receives vehicle information (step 303) from user computer 114. Appraiser computer 124 may store the received information in data storage device 230. The vehicle information may include description information, condition information and history information. User 110 may provide the information to appraiser computer 124 through user computer 114. An interactive user interface provided by appraiser computer 124 at user computer 114 may prompt user 110 to input the vehicle information. For example, to obtain vehicle 118's condition information, the user interface may ask that the user 110 specify the condition of the exterior body of the vehicle 118 by identifying a number of dents, dings, and scratches in respective panels of the exterior body of the vehicle. Similar prompts from valuation module 226 may ask for details about vehicle 118's mechanical and operational condition. Likewise, valuation module 226 may ask specific details about the maintenance, upkeep and repairs performed on vehicle 118. In some embodiments, the user interface provided by valuation module 226 may be consistent with that disclosed in International Application No. WO 01/71458 A2, the disclosure of which is incorporated herein by reference in its entirety.

Using the vehicle description information, valuation module 226 may retrieve a base price for vehicle 118 from market value database 250. (Step 305.) The initial value may be, for example, a value of an “ideal vehicle” that is provided from a database of prices based on, for example, the VIN, year, make and/or model of the vehicle.

In addition, valuation module 226 may select a price adjustment category for vehicle 118. (Step 308.) The category may be selected from a predefined set of category information 232 stored in data storage device 230. Using the selected price adjustment category, a base value that can be determined from the price of the ideal vehicle of that type. (Step 311.)

Modifier values can be retrieved from modifier information 234 based on the received condition information and history information stored in received vehicle information 238. (Step 314.) Modifier values are price addition and subtractions retrieved from modifier information 234 stored in data storage device 230 in modifier information 234. The addition or subtraction from the base value for vehicle 118 due to a modifier value may be capped to a predetermined threshold value. The threshold may be, in some cases, a flat amount. In other cases, the threshold value may be limited to a certain percentage of the vehicle 118.

For example, base value of vehicle 118 may be changed using a modifier value for the vehicle's current mileage. The actual mileage, as opposed to a range of mileage, can be used to calculate the vehicle 118's value. The modifier information 234 may include reduction rate (e.g., a depreciation curve or algorithm) for mileage that is reduced or capped after a certain amount of miles have been calculated in relation to the base value for that specific vehicle. In some embodiments, the deduction for mileage is reduced before fifty percent of the vehicle 118's value is diminished. When adding value to vehicle 118 for low mileage, a different rate may add back half the value for low miles in the same fashion that a deduction is made for high mileage. For example, once approximately forty percent has been added back to vehicle 118's value, no additional value is added.

Each modifier value can be adjusted for a particular vehicle, such as vehicle 118, based on information stored in modifier information 234 and associated with the selected adjustment category. For example, with regard to mileage, an adjustment category may have a set of values to calculate the affect that mileage has on a specific vehicle type. The adjustment to a modifier value corresponding to a selected category may be based a flat amount, a set of amounts, a scaling factor or an algorithm that varies with respect to the modifier value. For instance, category information 232 may indicate that each deduction for a paint scratch is increased by twenty percent for vehicles in a particular category. Other modifier values for the same vehicle category may not be affected.

Valuation module 226 may determine whether one of the modifier values is a deduction due to a previous insurance claim. If not (step 317, no), the process may determine a guaranteed offer price for vehicle 118. If valuation module 226 makes a deduction for a previous insurance claim, (step 317, yes), valuation module 226 may provide a notification of the deduction to user 110 and/or insurer 140. (Step 320.) The notification may be sent automatically from appraiser computer 124 to user computer 114 or insurer computer 144. Based on this notification, insurer 140 may reimburse user 110 for some or all of the deduction.

Using the base value and modifier values, valuation module 226 determines a guaranteed offer price for vehicle 118 (step 328) and generates an offer certificate which may be provided to user 110 (step. 329). In some embodiments, the guaranteed offer price is not determined and/or provided to user 110 unless user 110 had submitted their contact information. (Step 323) In the case where no contact information has been received (step 323, no), valuation module 226 may control appraiser computer 124 to provide user 110 an estimated value for vehicle 118 and, indicate to user 110 that the user must provide contact information to receive the guaranteed offer price. (Step 325.) If user 110 subsequently provides contact information (step 326, yes), valuation module 226 may determine a guaranteed offer price (step 329) and/or generate a demand certificate for vehicle 110 (step 329). If user 110 refuses to provide contact information (step 326, no), the process may stop (step 330).

As described above, dealer module 228 may control appraiser computer 120 to provide received contact information 240 to one or more member-dealers, such as dealer 130, based on dealer information 236 retrieved from data storage device 230. (Step 237.) Dealer information 236 may identify the member-dealers as belongs to a corresponding categories and the contact information 240 ma be provided to particular dealers based on the dealers' respective participation category

In embodiments where contact information is not required or where user 110 has provided contact information (step 326, Yes), valuation module 226 may control appraiser computer 124 to determine a guaranteed offer price for vehicle 118 (step 328) and/or generate an offer certificate indicating the guaranteed offer price (step 329) that is provided to user 110 (step 331).

The offer certificate may provide a complete summary of the condition of vehicle 118 as input by user 110. The summary may include, for example, vehicle 118's VIN, year, make, model, exterior color, interior color, OEM options, exterior flaws, tire condition, wheel condition, interior flaws, frame damage report and/or value. The information provided on the offer certificate is verifiably accurate for vehicle 118. As such, dealer 130, may accept the offer certificate as a payment of value, and user 110 can provide the certificate to dealer 130 as part of the new or used vehicle transaction.

In other embodiments, vehicle 118's VIN may be required to generate an offer certificate. (Step 323.) If the received contact information 240 or vehicle information 238 for vehicle 118 does not include the VIN, valuation module 226 may control appraiser computer 124 to provide user an estimated value for their vehicle type and inform user 110 that a VIN must be provided before an offer certificate is provided. (Step 325.) If user 110 provides the VIN (step 326, Yes) for vehicle 118, an offer certificate may be determined (step 328), a offer certificate generated (step 329) that is provided to user 110 and or dealer 130 (step 331).

When user 110 provides the offer certificate at a dealer that is a member of the service (step 335), such as dealer 130, along with proof of ownership, dealer 130 may inspect the vehicle and verify that the vehicle information provided by user 110 to appraiser computer 124 was accurate. In the event that the information was not accurate, dealer may void the guaranteed offer. (Step 341, “no” and Step 345.) User 110 or dealer 130 may then resubmit the vehicle to appraiser computer 124 and obtain an updated offer certificate. (Step 303.)

In the event that user 110 provided accurate vehicle information to appraiser computer 124, dealer 130 may purchase vehicle 118 from user 110 for the guaranteed offer price indicated on the offer certificate. (Step 343.) Of course, dealer would have the option of paying user 110 more than the guaranteed offer price. After purchasing vehicle 118, dealer 130 may sell vehicle 118 to appraiser 120 for the guaranteed offer price.

As disclosed herein, embodiments and features can be implemented through computer hardware and/or software. Such embodiments can be implemented in various environments, such as networked and computing-based environments with one or more users. The disclosed embodiments, however, are not limited to such examples, and the embodiments can be implemented with other platforms and in other environments.

Other embodiments of the invention will be apparent to those skilled in the art from consideration of the specification and practice of the embodiments of the invention disclosed herein. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. A method for generating a guaranteed offer price for a particular vehicle by an appraiser, wherein an appraiser computer is communicatively linked to a user computer and a database of market values for vehicle types, said method comprising:
selecting by the appraiser computer a price adjustment category for the vehicle from a set of price adjustment categories stored in a data storage device, said appraiser computer selecting said category based on vehicle type information received from the user computer;
determining by the appraiser computer a base value for the vehicle, said appraiser computer determining said base value being by modifying a market value of a vehicle type retrieved from the database based on an amount corresponding to the selected price adjustment category;
determining by the appraiser computer a modifier value based on vehicle information received from the user computer, said appraiser computer limiting the amount said modifier value being limited to a threshold value;
determining by the appraiser computer a guaranteed offer price for the vehicle, said appraiser computer determining said guaranteed offer price by combining the base value, and the modifier value; and
generating by the appraiser computer an offer certificate indicating the guaranteed offer price for the particular vehicle, wherein the guaranteed offer price is a value the appraiser must pay the dealer for the vehicle after the dealer has purchased the vehicle from the user based on the offer certificate; and
transmitting by the appraiser computer, over a communication link to the user computer, the offer certificate.

2. The method of claim 1, wherein the user information is received after transmitting an estimated price and before a guaranteed price is transmitted to the local terminal.

3. The method of claim 1, wherein the modifier value is determined based on a value associated with the selected price adjustment category.

4. The method of claim 1, wherein the modifier value is based on information received from the user computer describing the condition of the vehicle or the history of the vehicle.

5. The method of claim 1, wherein the threshold of the modifier value is a percentage of the base value.

6. The method of claim 1, wherein the threshold of the modifier value is a fixed value.

7. The method of claim 1, wherein a plurality of modifiers values are determined, each of said modifier values having a threshold value.

8. The method of claim 1, wherein the price adjustment category is selected based on the vehicles, make, model, and color.

9. The method of claim 1, wherein the price adjustment category defines a depreciation curve of a vehicle type.

10. The method of claim 1, wherein the customer information is provided to a dealer.

11. The method of claim 10, wherein the dealer belongs to a set of categories and the customer information is provided to a dealer based on a respective one of the participation categories.

12. The method of claim 1, wherein:
the modifier value includes deduction amount corresponding to accident damage, and
an insurer reimburses the user for said deduction amount corresponding to said accident damage.

13. A system for generating a guaranteed offer price for a particular vehicle by an appraiser computer, said system comprising:
a database of market values for vehicle types;
a processor;
a data storage device storing instructions that, when executed by the processor, control the appraiser computer to:
select a price adjustment category for the vehicle from a set of price adjustment categories stored in a data storage device, wherein the appraiser computer selects said category based on vehicle type information received from the user computer;
determine a base value for the vehicle, wherein the appraiser computer determines said base value being by modifying a market value of a vehicle type retrieved from the database based on an amount corresponding to the selected price adjustment category;
determine a modifier value based on vehicle information received from the user computer, wherein the appraiser computer limits the amount said modifier value being limited to a threshold value;
determine a guaranteed offer price for the vehicle, wherein the appraiser computer determines said guaranteed offer price by combining the base value, and the modifier value; and
generate by the appraiser computer an offer certificate indicating the guaranteed offer price for the particular vehicle, wherein the guaranteed offer price is a value the appraiser must pay the dealer for the vehicle after the dealer has purchased the vehicle from the user based on the offer certificate; and
transmit, over a communication link to the user computer, the offer certificate.

14. The system of claim 13, wherein the user information is received after transmitting an estimated price and before a guaranteed price is transmitted to the local terminal.

15. The system of claim 13, wherein the modifier value is determined based on a value associated with the selected price adjustment category.

16. The system of claim 13, wherein the modifier value is based on information received from the user computer describing the condition of the vehicle or the history of the vehicle.

17. The system of claim 13, wherein the threshold of the modifier value is a percentage of the base value.

18. The system of claim 13, wherein the threshold of the modifier value is a fixed value.

19. The system of claim 13, wherein a plurality of modifiers values are determined, each of said modifier values having a threshold value.

20. The system of claim 13, wherein the price adjustment category is selected based on the vehicles, make, model, and color.

21. The system of claim 13, wherein the price adjustment category defines a depreciation curve of a vehicle type.

22. The system of claim 13, wherein the customer information is provided to a dealer.

23. The system of claim 22, wherein the dealer belongs to a set of categories and the customer information is provided to a dealer based on a respective one of the participation categories.

24. The system of claim 13, wherein:
the modifier value includes deduction amount corresponding to accident damage, and
an insurer reimburses the user for said deduction amount corresponding to said accident damage.

25. A system for generating a guaranteed offer price for a particular vehicle by an appraiser, wherein an appraiser computer is communicatively linked to a user computer and a database of market values for vehicle types, said system comprising:
means for selecting a price adjustment category for the vehicle from a set of price adjustment categories stored in a data storage device, wherein the appraiser computer selects said category based on vehicle type information received from the user computer;
means for determining a base value for the vehicle, wherein the appraiser computer determines said base value being by modifying a market value of a vehicle type retrieved from the database based on an amount corresponding to the selected price adjustment category;
means for determining a modifier value based on vehicle information received from the user computer, wherein the appraiser computer limits the amount said modifier value being limited to a threshold value;
means for determining a guaranteed offer price for the vehicle, wherein the computer determines said guaranteed offer price by combining the base value, and the modifier value; and
generating by the appraiser computer an offer certificate indicating the guaranteed offer price for the particular vehicle, wherein the guaranteed offer price is a value the appraiser must pay the dealer for the vehicle after the dealer has purchased the vehicle from the user based on the offer certificate; and
means for transmitting, over a communication link to the user computer, the offer certificate.

26. A computer-readable storage device storing program instructions that, when executed by a processor, controls an appraiser computer to:
select a price adjustment category for the vehicle from a set of price adjustment categories stored in a data storage device, wherein the appraiser computer selects said category based on vehicle type information received from the user computer;
determine a base value for the vehicle, wherein the appraiser computer determines said base value being by modifying a market value of a vehicle type retrieved from the database based on an amount corresponding to the selected price adjustment category;
determine a modifier value based on vehicle information received from the user computer, wherein the appraiser computer limits the amount said modifier value being limited to a threshold value;
determine a guaranteed offer price for the vehicle, wherein the appraiser computer determines said guaranteed offer price by combining the base value, and the modifier value; and
generate by the appraiser computer an offer certificate indicating the guaranteed offer price for the particular vehicle, wherein the guaranteed offer price is a value the appraiser must pay the dealer for the vehicle after the dealer has purchased the vehicle from the user based on the offer certificate; and
transmit, over a communication link to the user computer, the offer certificate.
